(19) United States
(12) Patent Application Publication
(10) Pub. No.: US 2016/0005013 A1
(43) Pub. Date: Jan. 7, 2016

(54) REAL-TIME REGIONAL MEDIA SYNDICATION AND DELIVERY SYSTEM

(71) Applicant: SYNCBAK, INC., Cedar Rapids, IA (US)

(72) Inventor: Jack F. PERRY, Cedar Rapids, IA (US)

(21) Appl. No.: 14/791,079

(22) Filed: Jul. 2, 2015

Related U.S. Application Data
(60) Provisional application No. 62/020,844, filed on Jul. 3, 2014.

(51) Int. Cl. G06Q 20/12; G06F 21/10; G06Q 30/08; G06F 17/30; G06Q 30/06; G06Q 30/02

(52) U.S. Cl. CPC G06Q 20/1235; G06Q 30/0641; G06Q 30/0264; G06Q 30/08; G06Q 30/0201; G06F 17/30241; G06F 17/30849; G06F 21/10

(57) ABSTRACT

Described herein are systems, methods, and media for forming syndication relationships, the systems methods and media comprising a database of content, a software module configured to provide an interface for a user to browse the content, and a software module configured to provide an interface for the user to purchase a syndication right for a content item.

### CROSS-REFERENCE TO RELATED APPLICATIONS

This application claims the benefit of U.S. Patent Application No. 62/020,844, filed Jul. 3, 2014, the entire disclosure of which is hereby incorporated herein by reference.

### BACKGROUND OF THE INVENTION

The computer-implemented system allows content owners, users, advertisers, and viewers to quickly collaborate to establish syndication and advertising relationships to deliver video content to individual viewers. The system is designed to simplify the syndication process that exists today.

### SUMMARY OF THE INVENTION

In some embodiments described herein are computer-implemented systems, methods and computer readable media that form syndication relationships between users and content owners and advertising relationships between users and advertisers. The system is designed to make syndication a low-friction, real-time transaction, as opposed to the annual, high friction, difficult process it is today. The system allows content owners to sell syndication rights of a content item to one or more users. In some embodiments, the purchase of a syndication right grants the user an exclusive right to a geographic territory for a specific period of time. In some embodiments, users syndicate an unlimited amount of content, which is aggregated into “channels”, or made available for on-demand viewing. In some embodiments, users offer their advertisers flexible advertising models to monetize the content they have syndicated. This content is made available to individual viewers for consumption on fixed or mobile viewing devices (e.g., smartphones, tablets, smart connected televisions, etc). The systems, methods and media allow the syndication process to be shortened from about 12 months to a second. Using the system, the user is able to test the content offering on a limited audience (with the concurrence of the content owner), before syndicating. The system displays and manages the content for forming syndication relationships, manages advertising placements, gathers analytics on viewership, and manages the individual viewing experience.

For broadcaster users, the systems, methods and media described herein provide a marketplace to identify content that will appeal to users of their targeted demographic characteristics within their broadcast region and license the ability to place ads specific to a particular market. For content producer users, the systems, methods and media described herein provide marketplace to promote their content to broadcasters and advertisers. For content consuming end users, the systems, methods and media described herein provide marketplace to view content and be presented with ads of local relevance.

In some aspects described herein are computer-implemented systems comprising: a digital processing device comprising an operating system configured to perform executable instructions and a memory device; a computer program including instructions executable by the digital processing device to create a marketplace for forming a syndication relationship comprising: a database of content, the content susceptible to syndication in a plurality of geographic regions, provided that the content is submitted by the owner or authorized representative of the content; a software module configured to provide an interface for a user to browse the content, the interface comprising content item previews, syndication availability in a geographic region for each content item, and number of advertisement breaks available for each content item; and a software module configured to provide an interface for the user to purchase a syndication right for a content item, the syndication right comprising: a purchase price, a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like sales, broadcasting, production and the like. In some embodiments each content item is susceptible to syndication during a plurality of time periods in each geographic region. In some embodiments, the syndication right further comprises a time period.

In some embodiments the system comprises a software module configured to provide an interface for allowing content owners to upload content. In some embodiments the system comprises a software module configured that allows the content owner to input one or more of a purchase price, a geographic region, or a time period. In some embodiments one or more content items comprise one or more seasons, each season comprising one or more episodes. In some embodiments the number of advertisement breaks available for each content item is designated per season and/or per episode. In some embodiments the interface for the user to browse the content further allows the user to access demographics and/or metrics for each content item. In some embodiments the system further comprises a software module configured to provide an interface for allowing the user to view all content for which they have a syndication right. In some embodiments the system further comprises a software module to display one or more of demographics or metrics for all content which the user has a syndication right. In some embodiments the system further comprises an auction provided that the purchase of a syndication right is a result of an auction. In some embodiments the system further comprises a software module that sets the purchase price based on analytics comprising viewer popularity and viewer popularity within a geographic region. In some embodiments the system further comprises a software module configured to provide an interface that allows a user who purchases a syndication right to more than one content item to group the content items into a channel. In some embodiments the system further comprises a software module configured to provide an interface that allows the user who purchases a content item to sell an advertisement right to an advertisement break to an advertisement owner, the advertisement right comprising a purchase price, a geographic region and a time period. In some embodiments the system further comprises a software module configured to provide an interface that allows an advertisement to be uploaded. In some embodiments the system further comprises a software module configured to provide an interface that allows an advertisement owner who purchases an advertisement right to upload an advertisement. In some embodiments prior to syndication purchase, the user is able to test the content item by showing the content item to one or more people in order to obtain market feedback, provided that the one or more people are one or more of advertisers, users, critics, or one or more members of the general public.

In another aspect described herein are computer implemented methods for establishing syndication relationships comprising the steps of: providing a database of content, the content susceptible to syndication in a plurality of geographic regions, provided that the content is submitted by the owner or authorized representative of the content; providing a software module configured to provide an interface for a user to browse the content, the interface comprising content item previews, syndication availability in a geographic region for each content item, and number of advertisement breaks available for each content item; and providing a software module configured to provide an interface for the user to purchase a syndication right for a content item, the syndication right comprising: a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period.

In another aspect described herein are computer readable storage media encoded with a computer program including instructions executable by a digital processing device to create a marketplace for forming syndication relationships comprising: a database of content, the content susceptible to syndication in a plurality of geographic regions, provided that the content is submitted by the owner or authorized representative of the content; a software module configured to provide an interface for a user to browse the content, the interface comprising content item previews, syndication availability in a geographic region for each content item, and number of advertisement breaks available for each content item; and a software module configured to provide an interface for the user to purchase a syndication right for a content item, the syndication right comprising: a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period.

### BRIEF DESCRIPTION OF THE DRAWINGS

FIGS. 1A, 1B, and 1C shows non-limiting examples of a marketplace for forming syndication relationships, in this case, a marketplace comprising an end user content portal comprising a software module configured to provide an interface to allow a user to browse and search for content.

FIGS. 2A, 2B, and 2C shows non-limiting examples of a marketplace for forming syndication relationships, in this case, a marketplace comprising an end user content portal comprising a software module configured to provide an interface to allow a user to access content item information.

FIG. 3 shows a non-limiting example of a marketplace for forming syndication relationships, in this case, marketplace comprising an end user content portal comprising a software module configured to provide an interface to allow a user to access a content item preview.

FIGS. 4A and 4B show non-limiting examples of a marketplace for forming syndication relationships, in this case, a marketplace comprising a software module configured to provide an interface to allow a user to browse and filter content.

FIGS. 5A and 5B show non-limiting examples of a marketplace for forming syndication relationships, in this case, a marketplace comprising a software module configured to provide an interface to allow a user to access a content item page.

FIG. 6 shows a non-limiting example of a marketplace for forming syndication relationships, in this case, a marketplace comprising a software module configured to provide an interface to allow a user to view syndication availability in a geographic region.

FIG. 7 shows a non-limiting example of a marketplace for forming syndication relationships, in this case, a marketplace comprising a software module configured to provide an interface to allow a user to view the number of advertisement breaks available for each content item.

FIG. 8 shows a non-limiting example of a marketplace for forming syndication relationships, in this case, a software module configured to provide an interface to allow a user to view the number of advertisement breaks available for each content item.

FIGS. 9A and 9B show non-limiting examples of a marketplace for forming syndication relationships, in this case, a marketplace comprising a shopping cart to purchase syndication rights for content items.

FIG. 10 shows a non-limiting example of a marketplace for forming syndication relationships, in this case, a software module configured to provide an interface to allow a user to view all content for which they have a syndication right.

FIG. 11 shows a non-limiting example of a marketplace for forming syndication relationships, in this case, a software module configured to provide an interface to allow a user to view all content for which they have a syndication right.

FIG. 12 shows a non-limiting example of a marketplace for forming syndication relationships, in this case, a software module configured to provide an interface to allow a user to browse content.

### DETAILED DESCRIPTION OF THE INVENTION

In certain aspects described herein are computer-implemented systems, methods and computer readable media that form syndication relationships between users and content owners and advertising relationships between users and advertisers. The system is designed to make syndication a low-friction, real-time transaction, as opposed to the annual, high friction, difficult process it is today. The system allows content owners to sell syndication rights of a content item to one or more users. In some embodiments, the purchase of a syndication right grants the user an exclusive right to a geographic territory for a specific period of time. In some embodiments, users syndicate an unlimited amount of content, which is aggregated into “channels”, or made available for on-demand viewing. In some embodiments, users offer their advertisers flexible advertising models to monetize the content they have syndicated. This content is made available to individual viewers for consumption on fixed or mobile viewing devices (smartphones, tablets, connected televisions, etc). The systems, methods and media allow the syndication process to be shortened from about 12 months to a second. Using the system, the user is able to test the content offering on a limited audience (with the concurrence of the content owner), before syndicating. The system displays and manages the content for forming syndication relationships, manages advertising placements, gathers analytics on viewership, and manages the individual viewing experience.

Described herein, in certain embodiments, are computer-implemented systems comprising: a digital processing device comprising an operating system configured to perform executable instructions and a memory device; a computer program including instructions executable by the digital processing device to create a marketplace for forming a syndication relationship comprising: a database of content, the content susceptible to syndication in a plurality of geographic regions, provided that the content is submitted by the owner or authorized representative of the content; a software module configured to provide an interface for a user to browse the content, the interface comprising content item previews, syndication availability in a geographic region for each content item, and number of advertisement breaks available for each content item; and a software module configured to provide an interface for the user to purchase a syndication right for a content item, the syndication right comprising: a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period.

Described herein, in certain embodiments, are computer implemented methods for establishing syndication relationships comprising the steps of: providing a database of content, the content susceptible to syndication in a plurality of geographic regions, provided that the content is submitted by the owner or authorized representative of the content; providing a software module configured to provide an interface for a user to browse the content, the interface comprising content item previews, syndication availability in a geographic region for each content item, and number of advertisement breaks available for each content item; and providing a software module configured to provide an interface for the user to purchase a syndication right for a content item, the syndication right comprising: a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period.

Described herein, in certain embodiments, are computer readable storage media encoded with a computer program including instructions executable by a digital processing device to create a marketplace for forming syndication relationships comprising: a database of content, the content susceptible to syndication in a plurality of geographic regions, provided that the content is submitted by the owner or authorized representative of the content; a software module configured to provide an interface for a user to browse the content, the interface comprising content item previews, syndication availability in a geographic region for each content item, and number of advertisement breaks available for each content item; and a software module configured to provide an interface for the user to purchase a syndication right for a content item, the syndication right comprising: a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Syndication

In some embodiments, the systems, methods and media described herein create a marketplace for forming a syndication relationship. In some embodiments the systems, methods and media provide a database of content, the content susceptible to syndication in a plurality of geographic regions, provided that the content is submitted by the owner or authorized representative of the content. In some embodiments the systems, methods and media provide an interface for a user to browse the content, the interface comprising content item previews, syndication availability in a geographic region for each content item, and number of advertisement breaks available for each content item. In some embodiments the systems, methods and media allow the user to purchase a syndication right for a content item, the syndication right comprising: a purchase price and a geographic region. In further embodiments, the systems, methods and media described herein manage the syndication rights across all regions and disallow broadcaster users with the same or overlapping broadcast regions to purchase rights to the same content during the same or overlapping time periods.

In some embodiments the number of advertisement breaks available for each content item is designated per season. In some embodiments the number of advertisement breaks available for each content item is designated per episode. In some embodiments the systems, methods and media further comprise an interface that allows the user who purchases a content item to sell an advertisement right to an advertisement break to an advertisement owner, the advertisement right comprising a purchase price, a geographic region and a time period. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period.

Syndication, in some aspects, involves the sale of the same good to many customers who then integrate it with other offerings and redistribute the good. In light of the disclosure provided herein, one of ordinary skill in the art will recognize that syndication of content susceptible to syndication involves the sale of a syndication right to one or more users who combine the content with other offerings (e.g. advertisements) and redistribute (e.g. broadcast) the content to viewers. In some embodiments, the system, methods and media described herein serve to manage the relationship between content owners, users and advertisers, whereby the system methods, and media allow content owners to sell syndication rights to their content to users, allow a user to purchase a syndication right to the content, allows a user who purchases a syndication right to sell an advertisement right to an advertiser, allows an advertiser to include an advertisement in the content, and broadcasts the content to viewers. In some embodiments the content owners originally generated the content and/or are authorized to sell syndication rights to the syndicatable content. In some embodiments the users are broadcast organizations. In some embodiments the users are responsible for the production of radio and television programs and/or their transmission. In some embodiments the user sells broadcast rights to distributors who provide the syndicatable content to viewers. In some embodiments advertisers are corporations or authorized representatives thereof who sell a product and/or service and promote their product and/or service during the viewing of a piece of syndicatable content.

In some embodiments of the systems, methods and media described herein, a plurality users purchase syndication rights to syndicatable content and sell advertisement rights therein. For instance, in the Cedar Rapids-Waterloo-Iowa City-Dubuque broadcast area, the users may be KCRG, KFXA, KFXB, KGAN, KIIN, KPXR, KRIN, KWKB, KWWF, and/or KWWL. Once a syndication right to a content item in a particular geographic region is purchased, a user is able to sell an advertisement right to a regional advertiser and/or transmit the content to one or more viewers. In some embodiments, when an advertisement right is purchased by an advertiser, the advertiser uploads an advertisement to be included in the transmission of the content item. In some embodiments, a user purchases a first syndicatable right to a content item in a first geographic region and purchases a second syndicatable right for the content item in a second geographic region, thus the user is able to broadcast the content item in both geographic regions.

By way of non-limiting example, where a broadcaster user has purchased syndication rights to a content item in a particular geographic region the broadcaster user optionally sells advertisement rights to a regional advertiser wishing to advertise in the syndicated region. The regional advertiser's ad content is integrated into the ad breaks of the content for user's viewing the content online within the syndicated region. Where no broadcaster user has purchased syndication rights to a content item in a particular geographic region, end users within that geographic region optionally view the content via an online media portal; however, national ads are integrated into the ad breaks of the content.

In some embodiments, the system, media and methods described herein manage the number of advertisement slots available for a content item. In light of the disclosure provided herein, those of ordinary skill in the art will recognize that, in some embodiments, the number of advertisements for a content item are designated based on an episode, a season, and/or a combination thereof. In some embodiments, a user is able to sell an advertisement right to an advertiser for an episode, a season, and/or a combination thereof. In some embodiments an advertiser is able to purchase an advertisement right for an episode, a season, and/or a combination thereof.

### Geographical and Temporal Limitations on the Syndication

In some embodiments the systems, methods and media described herein create a marketplace for forming a syndication relationship. In some embodiments the systems, methods and media provide a database of content, the content susceptible to syndication in a plurality of geographic regions, provided that the content is submitted by the owner or authorized representative of the content. In some embodiments each content item is susceptible to syndication during a plurality of time periods in each geographic region. In some embodiments, the syndication right further comprises a time period. In some embodiments the systems, methods and media provide an interface for a user to browse the content, the interface comprising content item previews, syndication availability in a geographic region for each content item, and number of advertisement breaks available for each content item. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like.

In some embodiments the systems, methods and media further comprise an interface that allows the user who purchases a content item to sell an advertisement right to an advertisement break to an advertisement owner, the advertisement right comprising a purchase price, a geographic region and a time period. In some embodiments the systems, methods and media further comprise a software module that sets the purchase price based on analytics comprising viewer popularity and viewer popularity within a geographic region. In some embodiments the systems, methods and media further comprise a software module that provides an interface that allows the user who purchases a content item to sell an advertisement right to an advertisement break to an advertisement owner, the advertisement right comprising a purchase price, a geographic region and a time period. In some embodiments the systems, methods and media further comprise a software module that provides an interface to display the geographic region available for a content item prior to purchase or sale of a syndication right and/or prior to purchase or sale of an advertisement right. In some embodiments the systems, methods and media further comprise a software module that allows the content owner to input one or more of a purchase price, a geographic region, or a time period.

In some embodiments, broadcast areas may be designated market areas (DMAs), zip codes, block groups, census tracts, cartographic levels, government-established areas/zones, geographic areas, broadcast stations and/or the like. In some embodiments, geographic regions may be designated market areas (DMAs), zip codes, block groups, census tracts, cartographic levels, government-established areas/zones, geographic areas, broadcast stations and/or the like. In some embodiments the geographic regions are the same or different than the broadcast areas. In light of the disclosure provided herein, one of ordinary skill in the art will recognize that a user may have the ability to broadcast syndicatable content to more than one geographic region (e.g., DMA, zip code, block group, census tract, cartographic level, government-established area/zone, geographic area, broadcast station and/or the like), thus a user may purchase a first syndication right and a second syndication right to a piece of syndicatable content, broadcast the syndicatable content to a first and second geographic region, respectively, and sell a first and a second advertisement right, respectively, provided that the first and second advertisement right are the same or different. In some embodiments the systems, methods and media described herein determine the geographic regions in which the syndicatable content will be popular with viewers.

In some embodiments, a syndication right will allow a user to broadcast a piece of syndicatable content for a period of time, provided that the period of time is one day, one week, two weeks, a month, six months, one year, two years, three years, five years, or ten years. In some embodiments, a syndication right will entitle a user to sell advertisement right to a piece of syndicatable content for a period of time, provided that the period of time is one day, one week, two weeks, a month, six months, one year, two years, three years, five years, or ten years. In some embodiments the systems, methods and media further comprise a software module that specifies a time period based on the expected period of time in which a content item will be popular with viewers. In some embodiments the systems, methods and media further comprise a software module to allow a syndicatable content owner to input a period of time for which a syndicatable right will entitle a user to broadcast the syndicatable content and sell one or more advertisement rights to the syndicatable content.

### Suitable Content

In some embodiments the systems, methods and media described herein create a marketplace for forming a syndication relationship. In some embodiments the systems, methods and media provide a database of content, the content susceptible to syndication in a plurality of geographic regions, provided that the content is submitted by the owner or authorized representative of the content. In some embodiments each content item is susceptible to syndication during a plurality of time periods in each geographic region.

In some aspects, many types of syndicatable content are compatible with the systems, methods and media described herein. In some embodiments, syndicatable content comprises any type of media, whether audio, video, text, and/or the like. For example, syndicatable content comprises include television broadcasts (e.g., live local newscasts), television programs (e.g., The Office), sporting events, movies (e.g., video-ondemand (VOD)), datacasts, music, images, videos, text, webpages, and/or the like. In some embodiments, advertisements comprise any type of media, whether audio, video, text, and/or the like. For example, advertisements comprise commercials, ads, classified ads, infomercials, announcements, public service announcements, and/or the like.

### Interface for Uploading Content

In some embodiments the systems, methods and media described herein create a marketplace for forming a syndication relationship. In some embodiments the systems, methods and media provide a database of content, the content susceptible to syndication in a plurality of geographic regions, provided that the content is submitted by the owner or authorized representative of the content. In some embodiments the systems, methods and media provide an interface for a user to browse the content, the interface comprising content item previews, syndication availability in a geographic region for each content item, and number of advertisement breaks available for each content item. In some embodiments, the systems, methods and media described herein comprise a software module configured to provide an interface for the user to purchase a syndication right for a piece of syndicatable content, the syndication right comprising a purchase price, a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period. In some embodiments, the systems, methods and media described herein comprise a software module configured to provide an interface that uploads content input by content owners. In some embodiments, the systems, methods and media described herein comprise an interface that uploads an advertisement. In some embodiments, the systems, methods and media described herein comprise a software module configured to provide an interface for an advertisement owner who purchases an advertisement right to upload an advertisement.

In some embodiments, the systems, methods and media described herein comprise a software module configured to provide an interface that uploads content input by content owners. In some embodiments, the content is a data file located on the content owner's local computer, network attached storage device, external computer readable storage device, a cloud computer, a cloud storage device, and the like. In some embodiments, the content is manually uploaded, for example, by typing a file path to a content item, using a pointing device to select a content item, using a touchscreen to select a content item, using voice recognition to select a content item, and the like. In some embodiments the content is uploaded using a software such as a computer program and/or a script, provided that a computer program and/or a script is written in a computer readable language comprising javascript, C#, C, C++, bash, php, html, pyhton, and/or perl. In some embodiments, the content owner executes the upload of a content item by selecting an “upload” button, icon, link, and/or selectable text. In some embodiments the interface for uploading content is a graphical user interface with one or more windows and/or “pop-up” windows.

In some embodiments, the systems, methods and media described herein comprise a software module configured to provide an interface that uploads an advertisement input by advertisers and/or users. In some embodiments the advertisement is a data file located on the advertiser's and/or users local computer, network attached storage device, external computer readable storage device, a cloud computer, a cloud storage device, and the like. In some embodiments, the advertisement is manually uploaded, for example, by typing a file path to the advertisement, using a pointing device to select the advertisement, using a touchscreen to select the advertisement, using voice recognition to select the advertisement, and the like. In some embodiments the advertisement is uploaded using a software such as a computer program and/or a script, provided that a computer program and/or a script is written in a computer readable language comprising javascript, C#, C, C++, bash, php, html, pyhton, and/or perl. In some embodiments, the advertisement owner and/or the user executes the upload of an advertisement by selecting an “upload” button, icon, link, and/or selectable text. In some embodiments the interface for uploading advertisement is a graphical user interface with one or more windows and/or “pop-up” windows.

### Interface for Browsing Content

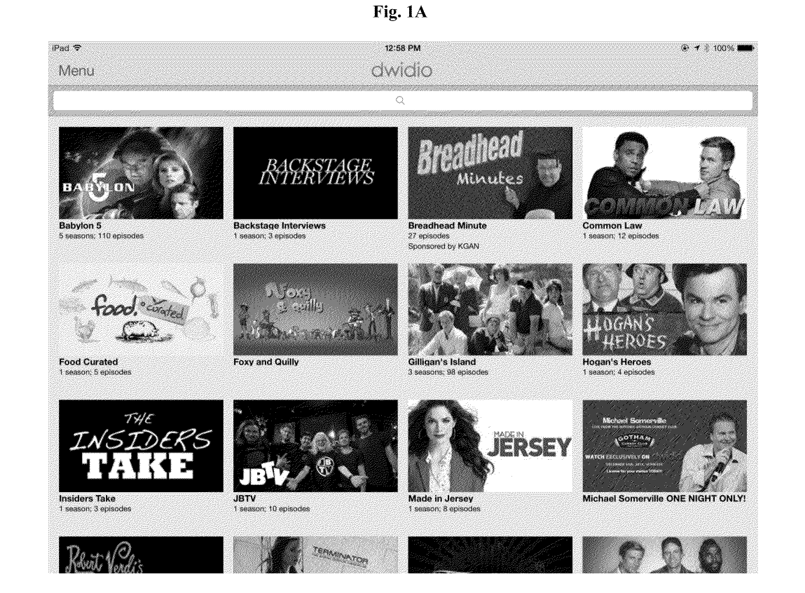

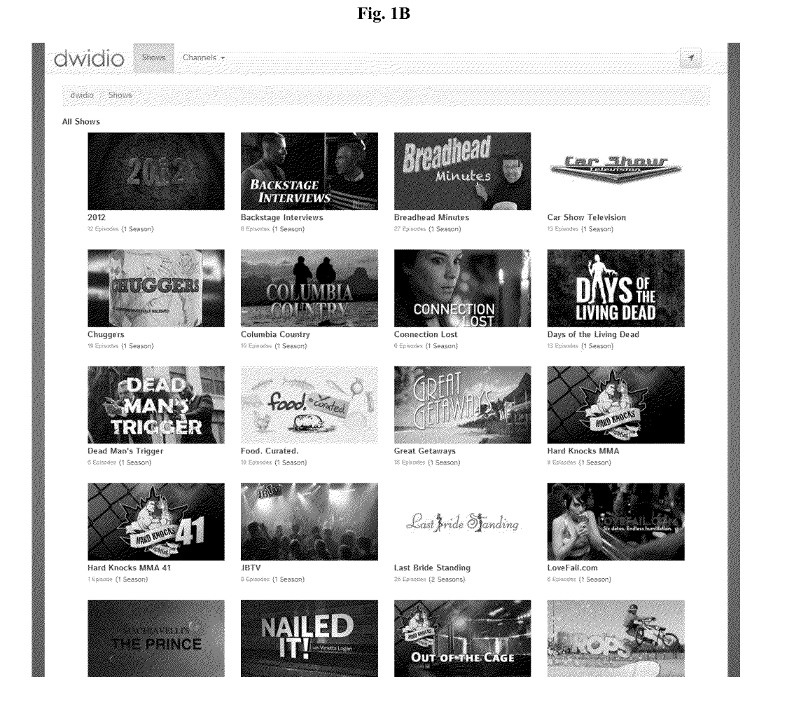

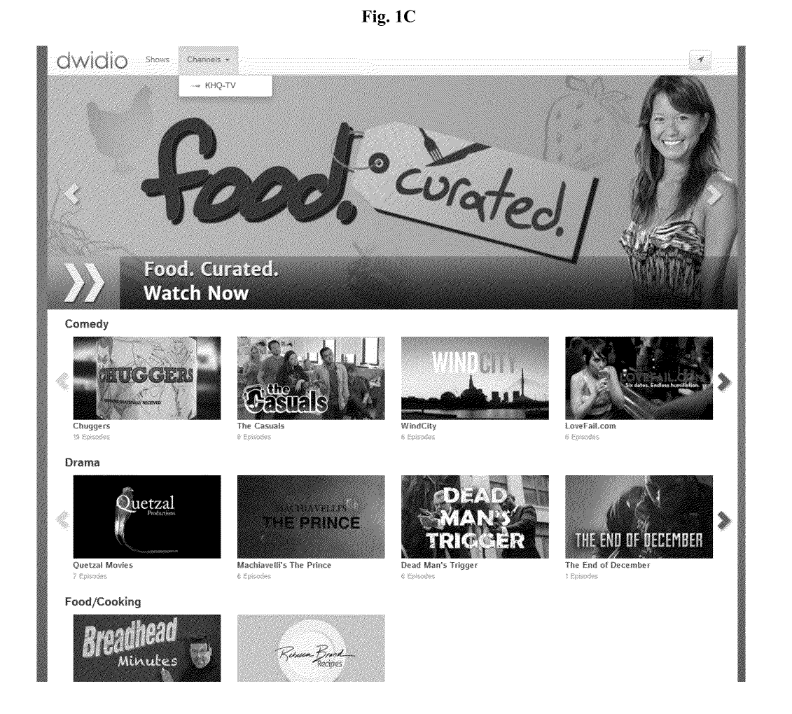

In some embodiments the systems, methods and media described herein create a content portal for allowing consuming end users to browse and view content. See, e.g., FIGS. 1A-3. In further embodiments, the content is free and can be accessed by the end users free of charge. In still further embodiments, ads integrated into the content before the content, after the content, and/or at pre-defined ad breaks within the content. In some embodiments, the ads are national ads. In other embodiments, the ads are regional ads. In further embodiments, a party has purchased syndication rights to a piece of content and in a particular geographical region and thus acquired the ability to specify the ads that will be shown to the end users located in the syndicated geographical region.

Referring to FIGS. 1A and 1B, in some embodiments, an interface to browse content comprises one or more images, a title, a description, a number of episodes, a number of seasons, and/or a combination thereof of a content item. In some embodiments, the images and/or titles and/or descriptions are selectable using a pointing device, a touchscreen, voice recognition, and the like. In some embodiments, the interface is configured to display a plurality of pieces of content, provided that each content item is displayed using an image and/or a title and/or a description. In some embodiments the content item displayed on the interface is one or more episodes and/or one or more seasons. In some embodiments, the content is searchable.

Referring to FIG. 1C, in some embodiments, an interface to browse content comprises content categories to further organize the content. In this particular embodiment, the content categories include comedy, drama, and food/cooking Those of skill in the art will recognize that many content categories are suitable including, by way of non-limiting examples, action, adventure, animated, automotive, aviation, bloopers, business, comedy, detective, drama, documentary, fantasy, fashion, food and drink, game show, history, horror, inspirational, legal, medical, military, music, mystery, paranormal, police, reality, religious, school, sci-fi, suspense, sports, talent, thriller, travel, and variety.

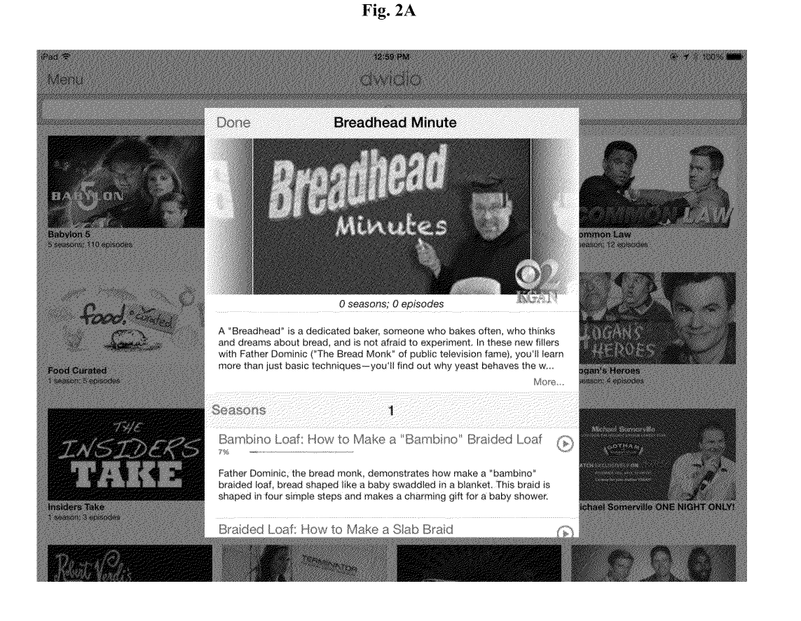

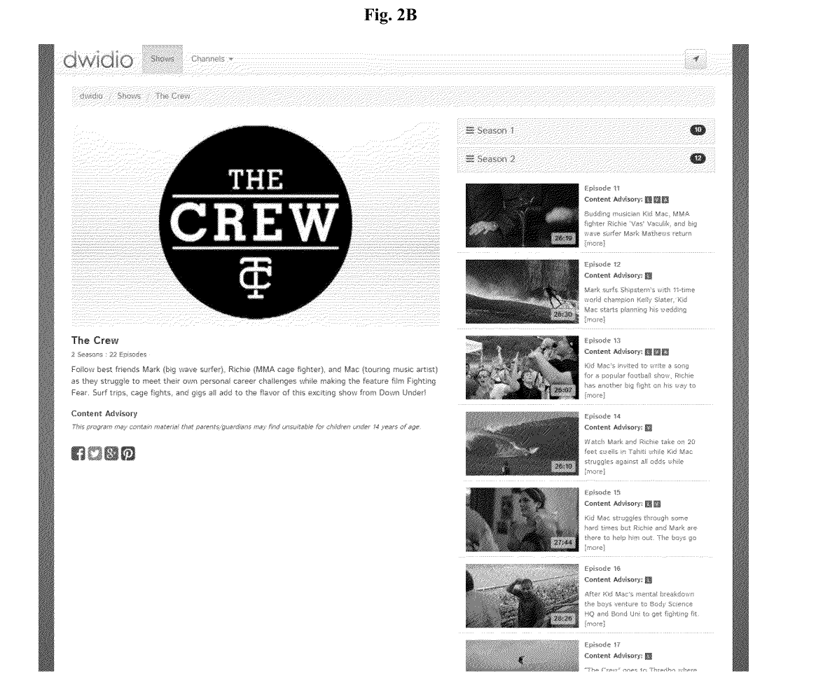

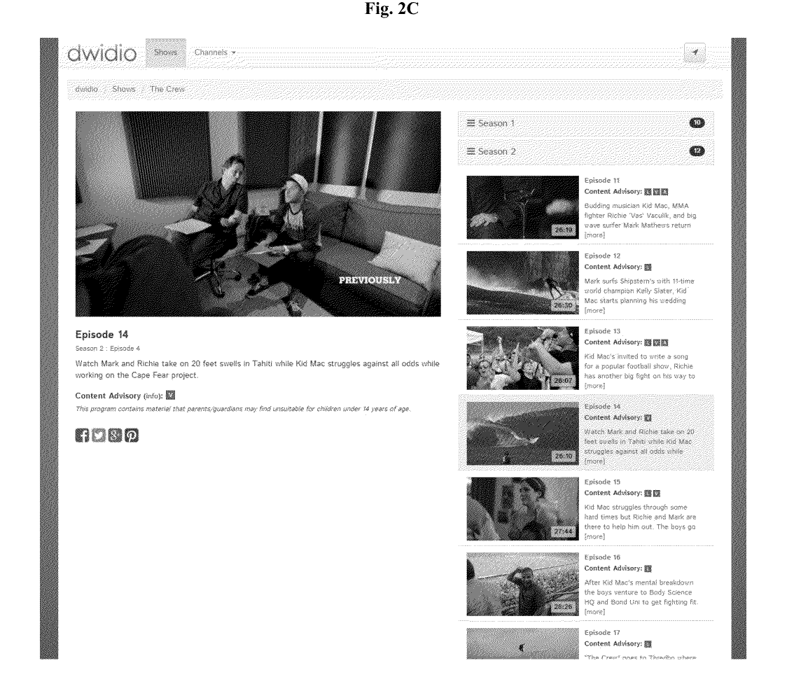

Referring to FIG. 2A, in some embodiments, when a content item is selected the interface is configured to display a first window, the first window comprising one or more images, an expandable description, a title, a heading, a season indicator, and an episode indicator. In some embodiments the first window allows selection of one or more episodes.

Referring to FIGS. 2B and 2C, in some embodiments, each content item is associated with a content page. A content page is suitably directed to a series, a season, or an episode. In these particular embodiments, a content page is directed to a series and offers users the ability to observe the number of seasons and the number of episodes in each season. In these embodiments, for each episode, the view is presented with advisories, a description, and access to a content preview.

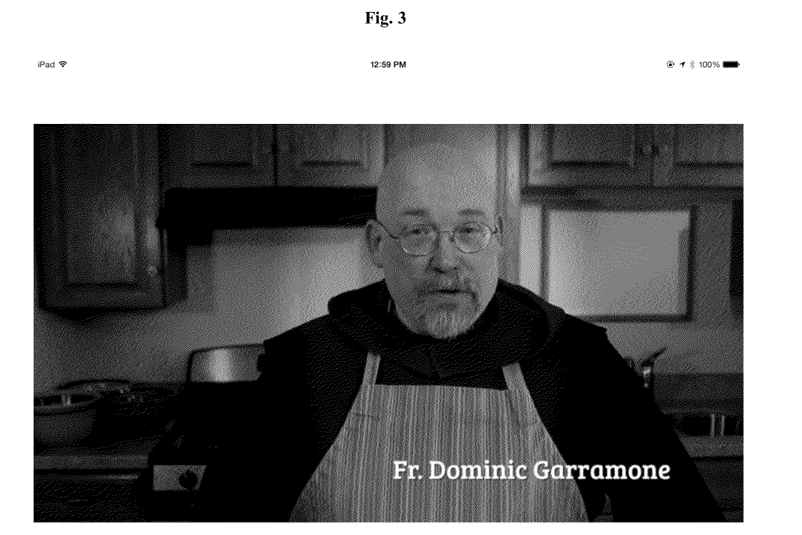

Referring to FIG. 3, in some embodiments, selecting an episode and/or a season in the first window starts a media player to preview the episode and/or season. In some embodiments the second window allows different episodes and/or seasons to be selected.

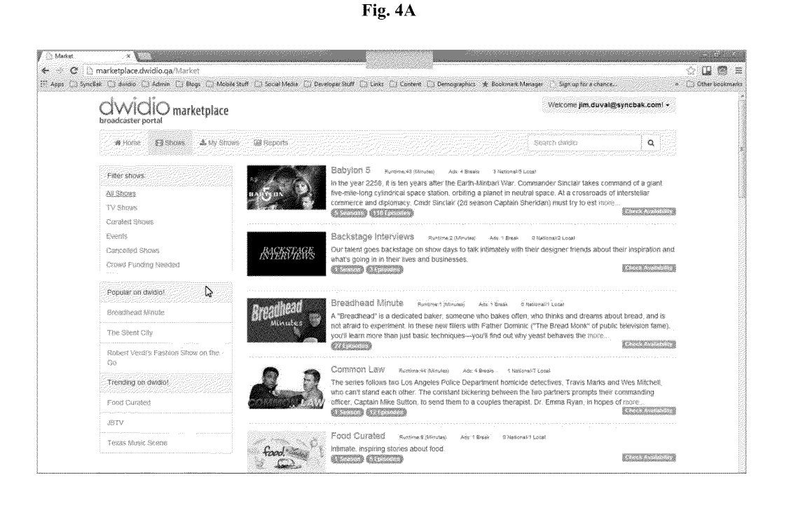

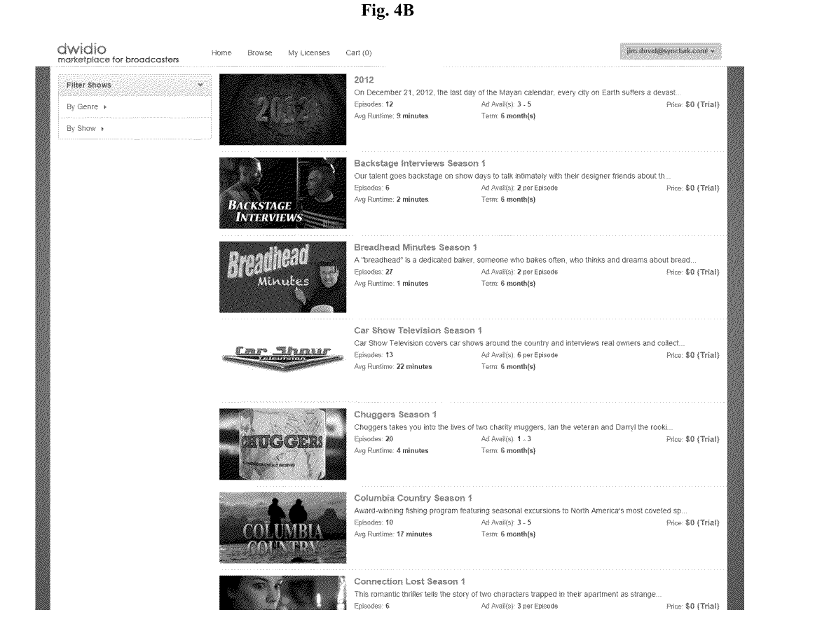

In some embodiments the systems, methods and media described herein create a marketplace for forming a syndication relationship. See, e.g., FIGS. 4A-12. In some embodiments the systems, methods and media provide a database of content, the content susceptible to syndication in a plurality of geographic regions, provided that the content is submitted by the owner or authorized representative of the content. In some embodiments the systems, methods and media provide an interface for a user to browse the content, the interface comprising content item previews, syndication availability in a geographic region for each content item, and number of advertisement breaks available for each content item. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments the systems, methods and media provide an interface for the user to access demographics and/or metrics for each content item. In some embodiments the number of advertisement breaks is designated per season and/or per episode. In some embodiments, prior to syndication purchase, the user is able to test the content item by showing the content item to one or more people in order to obtain market feedback. In some embodiments, the one or more people are one or more of advertisers, users, critics, or one or more members of the general public.

Referring to FIG. 4A, in some embodiments, a marketplace for forming syndication relationships comprises an interface allowing a broadcaster user to check the availability of syndication rights for content items. In some embodiments the availability is a time period comprising, one day, one week, two weeks, one month, two months, six months, one year, two years, five years, and/or ten years. In some embodiments, a purchase price is displayed for each time period.

Referring to FIG. 4B, in some embodiments, a marketplace for forming syndication relationships comprises an interface allowing a broadcaster user to view syndication right details for content. In this particular embodiment, the interface displays run time, number of ad breaks, a syndication term for each content item.

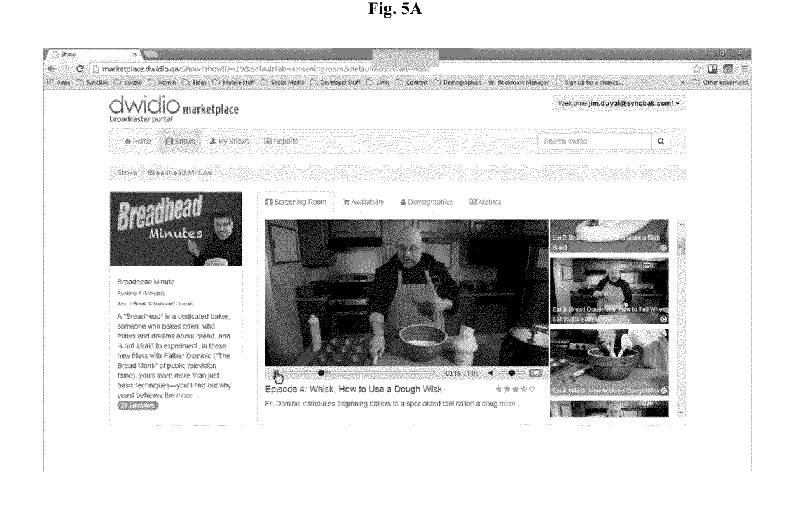

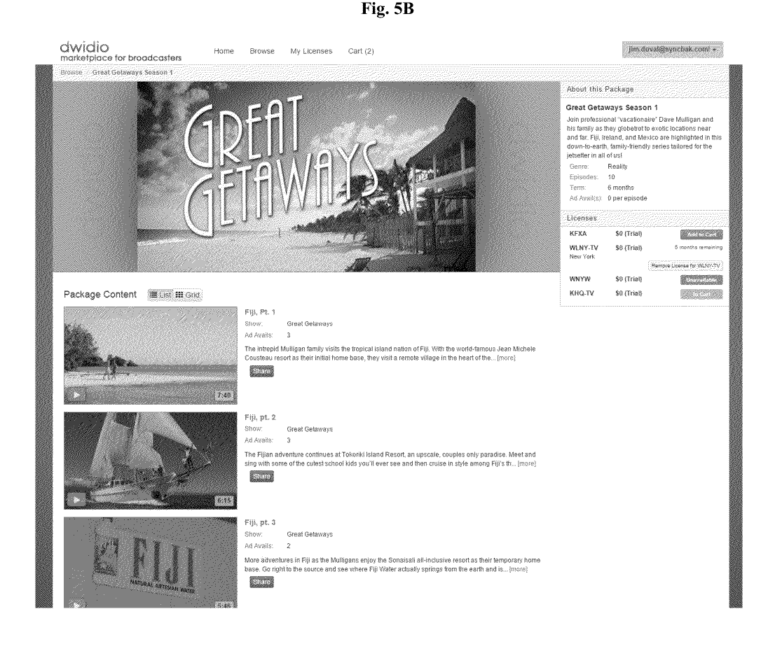

Referring to FIG. 5A, in some embodiments, a marketplace for forming syndication relationships comprises an interface allowing a broadcaster user to view a content page for each content item. In this particular embodiment, a content page comprises a description, a screening room for viewing the content, and syndication rights availability tool for allowing the user to observe whether rights are available in a particular geographic region, a demographics tool allowing the user to observe demographics information for the content, and a metrics tool.

Referring to FIG. 5B, in some embodiments, a marketplace for forming syndication relationships comprises an interface allowing a broadcaster user to view a content package page for a content package. In this particular embodiment, a content package page comprises a description of the package and each content item in the package, a preview of each content item in the package, and a list of available and unavailable syndication rights for the package in particular geographic regions.

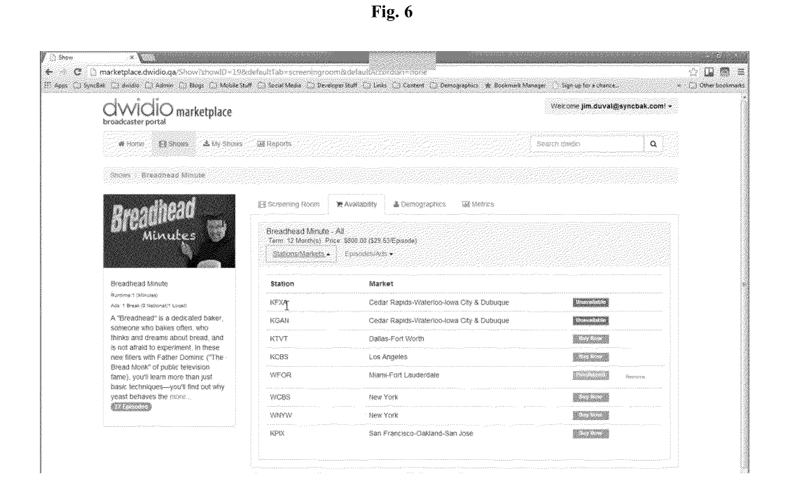

Referring to FIG. 6, in some embodiments, a marketplace for forming syndication relationships comprises an interface allowing a broadcaster user to view a list of available and unavailable syndication rights for the package in particular geographic regions. In this particular embodiment, each right includes a station, a market (e.g., a geographic region), and a status indicator (e.g., unavailable, purchased, or buy now). In this embodiment, the availability of a content item is displayed based on a geographic region, provided that the geographic regions comprise designated market areas (DMAs), zip codes, block groups, census tracts, cartographic levels, government-established areas/zones, geographic areas, broadcast stations and/or the like. In some embodiments availability is determined for an episode and/or a season.

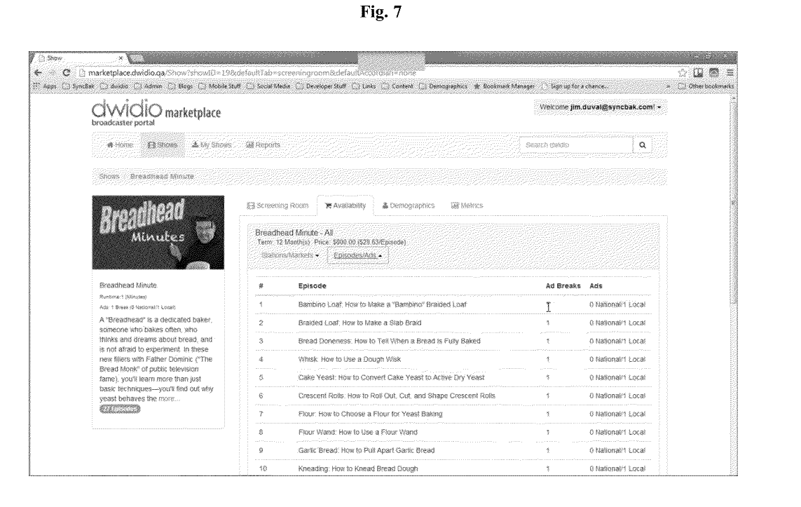

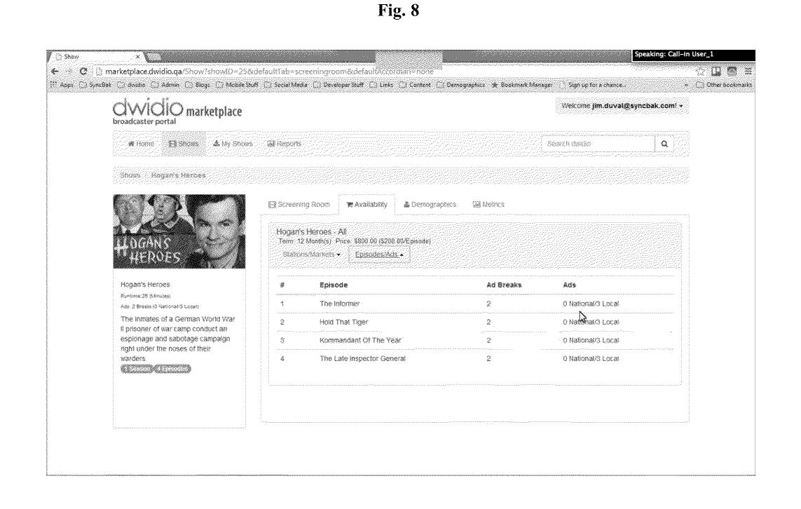

Referring to FIG. 7 and FIG. 8, in some embodiments, the systems, methods and media provide an interface for a broadcaster user to browse content, the interface comprising the number of advertisement breaks available for each content item. In some embodiments the number of advertisement breaks is designated per season and/or per episode. In some embodiments, the advertisement breaks are designated for national and/or local broadcasting of the content item. In this particular embodiment, the interface further provides a price and a syndication term for the content.

Referring to FIGS. 5A, 6, 7, and 8, in some embodiments, the systems, methods and media provide an interface for a broadcaster user to access demographics and/or metrics for each content item. Non-limiting examples of demographics include, age, sex, viewer interests based on geographic region, viewer interest based on a past time period, and the like. Non-limiting examples of metrics include, popularity rating of a content item, trending information for a content item, social media prevalence of a content item, recent viewing of a content item, recent syndication purchases of a content item, advertiser interest of a content item, and the like.

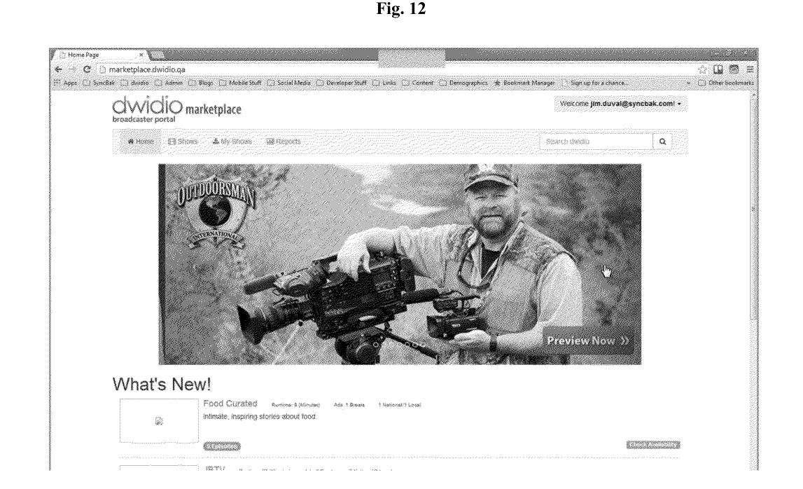

Referring to FIG. 12, in some embodiments, a marketplace for forming syndication relationships comprises a home page for a broadcaster user that indicates new and trending content items.

### Interface for Purchasing Syndication Rights

In some embodiments the systems, methods and media described herein create a marketplace for forming a syndication relationship. In some embodiments the systems, methods and media provide a database of content, the content susceptible to syndication in a plurality of geographic regions, provided that the content is submitted by the owner or authorized representative of the content. In some embodiments the systems, methods and media provide an interface for a user to browse the content, the interface comprising content item previews, syndication availability in a geographic region for each content item, and number of advertisement breaks available for each content item. In some embodiments, the systems, methods and media described herein comprise a software module configured to provide an interface for the user to purchase a syndication right for a piece of syndicatable content, the syndication right comprising a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period. In some embodiments, the systems, methods and media described herein further comprise a software module that sets the purchase price based on analytics comprising viewer popularity and viewer popularity within a geographic region. In some embodiments of the systems, methods and media described herein a purchase of a syndication right is the result of an auction.

In some embodiments of the systems, methods and media comprise a software module configured to provide a payment interface to allow purchase of a syndication right using a many methods of payment. In various embodiments, suitable methods of payment include, by way of non-limiting examples, credit, debit, electronic funds transfer, wire transfer, online money transfer services (e.g., PayPal), electronic wallet, digital currency (e.g., bitcoin, etc.), and the like.

In some embodiments, the systems, methods and media described herein further comprise a software module that sets the purchase price based on analytics comprising viewer popularity and viewer popularity within a geographic region. In some embodiments the analytics further comprise data based on viewing popularity, viewing age, viewer income, advertising revenue generated for a content item, number of advertising slots, geographic region and a combination thereof, is used to determine a purchase price for a syndication right. In some embodiments, the data are input into an algorithm, for example a learning algorithm, a classification algorithm a hierarchical algorithm and/or a monte-carlo algorithm, to determine a purchase price.

In some embodiments of the systems, methods and media described herein, a purchase of a syndication right is the result of and auction. In some embodiments users place bids in the form of a purchase price offer in order to purchase a syndication right to a content item. As a non-limiting example of an auction, a first user inputs a first purchase price offer for a content item; a second user is able to see the first purchase price offer and inputs a second higher purchase price offer in order to outbid the first user. This non-limiting example could be expanded to a plurality of users and/or a plurality of bids. In some embodiments, a minimum purchase price is set prior to the auction. In some embodiments, the minimum purchase price is based on analytics comprising viewer popularity and viewer popularity within a geographic region. In some embodiments the analytics further comprise data based on viewing popularity, viewing age, viewer income, advertising revenue generated for a content item, number of advertising slots, geographic region and a combination thereof, is used to determine a purchase price for a syndication right. In some embodiments the auction is pre-determined to last a period of time comprising, one day, two days, one week, two weeks, one month, two months, six months, one year, two years, or ten years.

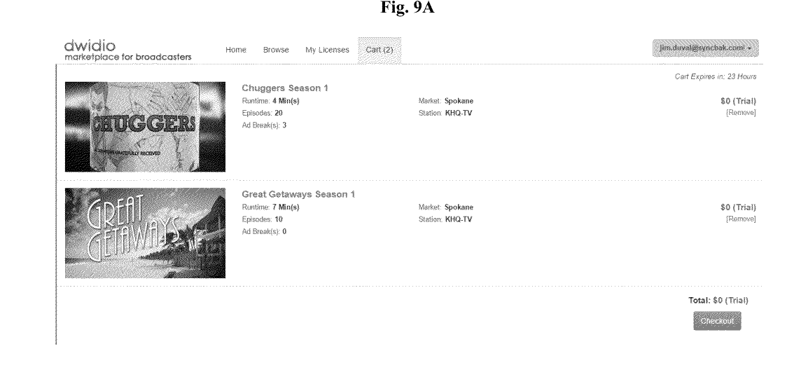

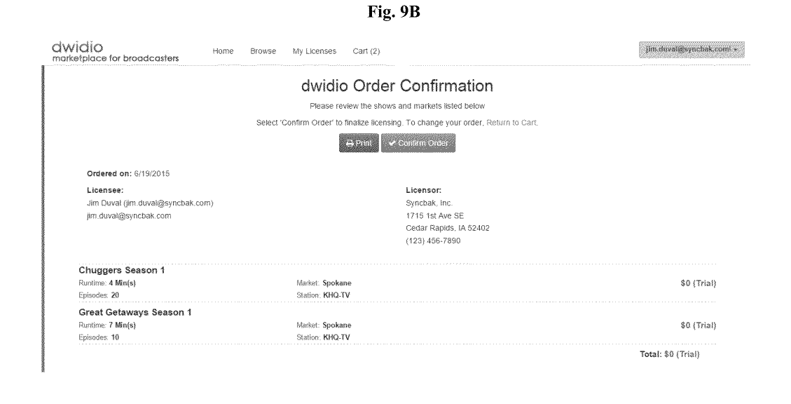

Referring to FIGS. 9A and 9B, in some embodiments, the systems, methods and media described herein comprise a software module configured to provide shopping cart feature for purchasing syndication rights to a content item. In these particular embodiments, the cart indicates: the content, the runtime, the ad breaks, the purchasing station, the geographic region associated with the rights, and the price.

### Interface for Viewing all Purchased Rights

In some embodiments the systems, methods and media described herein create a marketplace for forming a syndication relationship. In some embodiments the systems, methods and media provide a database of content, the content susceptible to syndication in a plurality of geographic regions, provided that the content is submitted by the owner or authorized representative of the content. In some embodiments the systems, methods and media provide an interface for a user to browse the content, the interface comprising content item previews, syndication availability in a geographic region for each content item, and number of advertisement breaks available for each content item. In some embodiments, the systems, methods and media described herein comprise a software module configured to provide an interface for the user to purchase a syndication right for a piece of syndicatable content, the syndication right comprising a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period. In some embodiments, the systems, methods and media described herein comprise a software module configured to provide an interface for allowing the user to view all content for which they have a syndication right. In some embodiments, the systems, methods and media described herein comprise a software module configured to provide an interface to display one or more of demographics or metrics for all content which the user has a syndication right.

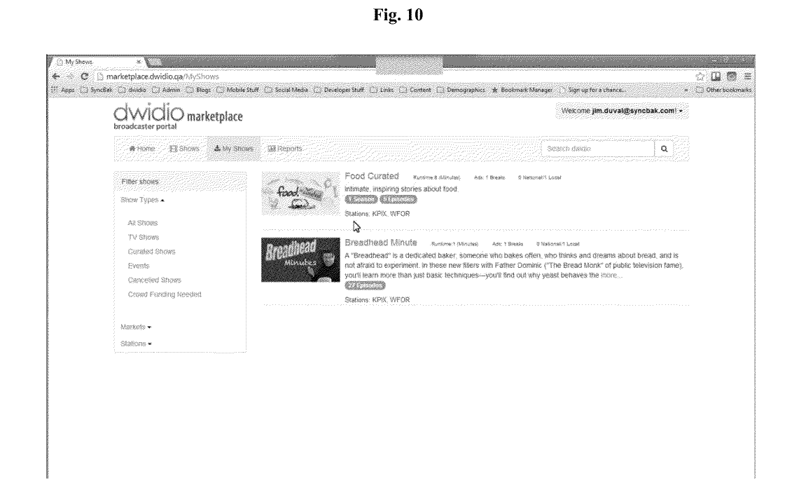

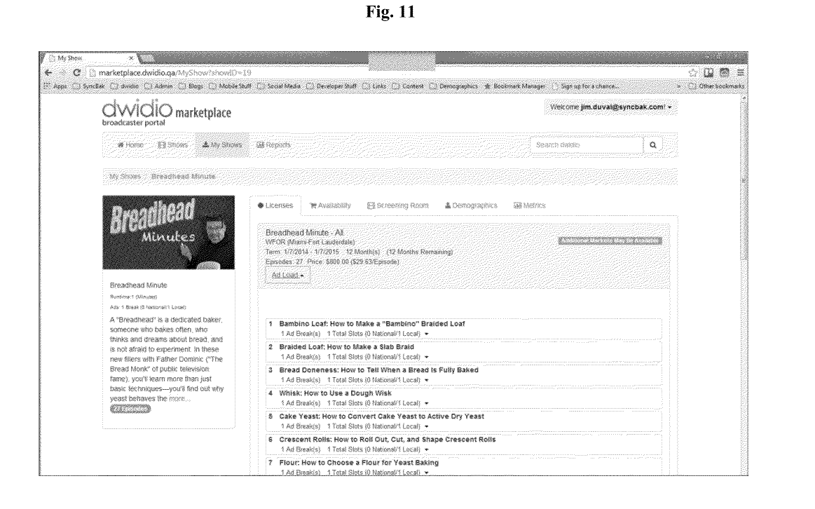

Referring to FIG. 10 and FIG. 11, in some embodiments, the systems, methods and media described herein comprise a software module configured to provide an interface for allowing the user to view all content for which they have a syndication right. In some embodiments, the interface for allowing the user to view all content for which they have a syndication right displays the number of episodes and/or the number of seasons for each content item for which the user has a syndication right. In some embodiments the interface for allowing the user to view all content for which they have a syndication right is configured to display the number of advertisement breaks available for each content item for which the user has a syndication right. In some embodiments, the advertisement breaks are designated for national and/or local broadcasting of the content item. In some embodiments, the interface for allowing a user to view all content for which they have a syndication right is configured to show the availability of the content item in geographic regions in which the user has not purchased a syndication right and/or allows the user to view a content item in a media player.

Referring to FIG. 10 and FIG. 11, in some embodiments, the systems, methods and media described herein comprise a software module configured to provide an interface to display one or more of demographics or metrics for all content which the user has a syndication right. Non-limiting examples of demographics include, age, sex, viewer interests based on geography, viewer interest based on a past time period, and the like. Non-limiting examples of metrics include, popularity rating of a content item, trending information for a content item, social media prevalence of a content item, recent viewing of a content item, recent syndication purchases of a content item, advertiser interest of a content item, and the like.

Interface for Testing Content with Advertisers

In some embodiments the systems, methods and media described herein create a marketplace for forming a syndication relationship. In some embodiments the systems, methods and media provide a database of content, the content susceptible to syndication in a plurality of geographic regions, provided that the content is submitted by the owner or authorized representative of the content. In some embodiments the systems, methods and media provide an interface for a user to browse the content, the interface comprising content item previews, syndication availability in a geographic region for each content item, and number of advertisement breaks available for each content item. In some embodiments, the systems, methods and media described herein comprise a software module configured to provide an interface for the user to purchase a syndication right for a piece of syndicatable content, the syndication right comprising a purchase price and a geographic region. In some embodiments, the user is a broadcaster. In some embodiments, the user comprises a web service provider, a former television salesperson, a person or entity currently or formerly associated with internet-based content streaming, viewing or sales, or a person or entity currently or formerly associated with television sales, broadcasting, production and the like. In some embodiments each content item is susceptible to syndication during a plurality of time periods in each geographic region. In some embodiments, the syndication right further comprises a time period. In some embodiments, prior to purchase of a syndication right, the user is able to test the content item by showing the content item to one or more people in order to obtain market feedback. In some embodiments, the one or more people are one or more of advertisers, users, critics, or one or more members of the general public.

In some embodiments, prior to purchase of a syndication right, the user is able to test the content item by showing the content item to one or more people in order to obtain market feedback. In some embodiments the user is able to test their specific DMA and/or multiple DMAs. In some embodiments, the one or more people are one or more of advertisers, users, critics, or one or more members of the general public. In some embodiments the market feedback comprises attractiveness, likeability, willingness to watch, interest level, and the like. In some embodiments, the user tests the content using the interface for a user to browse content comprising one or more images, a title, a description, a number of episodes, a number of seasons, and a combination thereof of a content item. In some embodiments, the images and/or titles and/or descriptions are selectable using a pointing device, a touchscreen, voice recognition, and the like.

Referring to FIG. 3, in some embodiments, a preview to a content item is shown to one or more people using a media player that is activated after a content item has been selected in the interface. In some embodiments the interface comprises QuickPanel. In some embodiments the systems, methods and media described herein comprise a feedback interface configured to receive responses from the one or more people who preview the content, the responses comprising questionnaires, ratings, rankings, and/or text input. In some embodiments, the user tests the content with one or more advertisers. In some embodiments, testing the content with one or more advertisers allows the user to obtain feedback that is used to determine whether to purchase a syndication relationship.

### End User Interface for Viewing Content

In some embodiments the systems, methods and media described herein integrate with an interface for allowing media-consuming end users to view content. In further embodiments, the end user interface for viewing content comprises a media portal, wherein users can view media. In still further embodiments, the media portal is an online streaming media portal. In some embodiments, the media portal is free. In other embodiments, the media portal requires a fee such as a subscription fee. In some embodiments, the media portal includes features to geolocate end users viewing media.

In some embodiments, the media includes ads. In further embodiments, where syndication rights to a particular media item, including a particular geographical region, have been licensed by a broadcaster and the ad rights have further been licensed to a regional advertiser, the regional ads are included in the ad breaks of the media when view by an end user located in the specified geographical region. In other embodiments, the ads are national ads.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of clinical trial, profile, and/or molecular phenotype information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

### Example

The following illustrative example is representative of an embodiment of the software applications, systems, and methods described herein and is not meant to be limiting in any way.

The first step in forming a syndication relationship is uploading syndicatable content by a content owner or authorized representative. For the purpose of this example, a content owner uploads a television show episode X and a television show episode Y using the interface that uploads content. Using a computer that stores files containing X and Y, the content owner uses the interface that uploads content to select X and Y using a pointer and executes the upload by clicking the upload button. The content owner also uploads text files (e.g. Microsoft Word™ files) describing X and Y and images representing X and Y to be displayed on the interface to browse content. The files containing X and Y, the text files and the images are uploaded and stored in a database containing syndicatable content. Once the files containing X and Y are uploaded to the database, geographic regions, periods of time, and purchase prices are assigned to X and Y.

At a later time, the user KCRG in the Cedar Rapids, Iowa accesses the interface to browse content using a computer. The user uses a pointer to click the image representing X opening up a window with a media player in which the user previews X. Displayed in the window is a purchase price of $100 and a period of time of one month. By clicking the “Stations/Markets” tab in the window, the available broadcast stations for X including KCRG, KFXA, and KFXB are displayed. By clicking on the “Episodes/Ads” tab in the window, the user is able to see that there are 2 advertisement slots available for X. Also, by clicking the “demographics” tab in the window, the user is informed that X is popular with children ages 6-9 in the Cedar Rapids, Iowa area. On clicking the “Metrics” tab, the user ascertains that multiple syndication rights to X were purchased in Dubuque, Iowa yesterday potentially indicating the show is gaining popularity in the area.

At a later time, the user decides to show X to an advertiser in order to obtain feedback. Using the interface to browse content, the user shows X to the advertiser. The advertiser provides verbal feedback indicating interest in purchasing the advertisement slots in X. After receiving the feedback from the advertiser, the user uses the payment interface and a credit card to purchase the syndication right to X for one month to be broadcast by the KCRG broadcast station.

At a later time, the user sells an advertisement right to the advertiser. The advertiser uses the interface that uploads an advertisement to upload a commercial. Using a computer that stores the advertisement, the advertiser uses the interface that uploads an advertisement to select the advertisement using a pointer and executes the upload by clicking the upload button.

After upload of the advertisement, the user accesses the interface for allowing the user to view all content for which they have a syndication right. Using the interface for allowing the user to view all content for which they have a syndication right, the user is able to see that the purchase of a syndication right to X for a time period of one month, that the two advertisement slots have been occupied by the advertisement uploaded by the advertiser, and that X is no longer available for the KFXA and KFXB broadcast stations.

What is claimed is:

1. A computer-implemented system comprising:
a. a digital processing device comprising an operating system configured to perform executable instructions and a memory device;
b. a computer program including instructions executable by the digital processing device to create a marketplace for forming a syndication relationship comprising:
a. a database of content, the content susceptible to syndication in a plurality of geographic regions, provided that the content is submitted by the owner or authorized representative of the content;
b. a software module configured to provide an interface for a user to browse the content, the interface comprising a preview for each content item, a syndication availability in a first geographic region for each content item, and a number of advertisement breaks available for each content item; and
c. a software module configured to provide an interface for the user to purchase a syndication right for a content item, the syndication right comprising: a purchase price and a second geographic region.

2. The system of claim 1, provided that the first geographic region is the same as the second geographic region.

3. The system of claim 1, provided that the user is a broadcaster.

4. The system of claim 1, provided that each content item is susceptible to syndication during a plurality of time periods in each geographic region.

5. The system of claim 4, provided that the syndication right further comprises a time period.

6. The system of claim 1, further comprising a software module configured to provide an interface to upload content, the content uploaded by the content owner.

7. The system of claim 1, further comprising a software module configured to receive a setting comprising a purchase price and a geographic region, the setting input by the content owner.

8. The system of claim 4, further comprising a software module configured to receive a setting comprising a purchase price, a geographic region, and a time period, the setting input by the content owner.

9. The system of claim 1, provided that one or more content items comprise one or more seasons, each season comprising one or more episodes.

10. The system of claim 9, provided that number of advertisement breaks available for each content item is designated per season.

11. The system of claim 9, provided that number of advertisement breaks available for each content item is designated per episode.

12. The system of claim 1, provided that the interface for the user to browse the content provides access to demographics for each content item.

13. The system of claim 1, provided that the interface for the user to browse the content provides access to metrics for each content item.

14. The system of claim 1, further comprising a software module configured to provide an interface to view the content to which the user has a syndication right.

15. The interface of claim 14, further comprising a software module to display one or more of demographics or metrics for the content to which the user has a syndication right.

16. The system of claim 1, provided that the purchase of a syndication right is a result of an auction.

17. The system of claim 1, further comprising a software module that sets the purchase price based on analytics comprising viewer popularity and viewer popularity within a geographic region

18. The system of claim 1, further comprising a software module configured to provide an interface to group the content items to which the user has purchased a syndication right into a channel.

19. The system of claim 1, further comprising an interface for the user who purchases the syndication right to sell an advertisement right to an advertisement break, the advertisement right comprising a purchase price and a geographic region.

20. The system of claim 19, provided that the advertisement right further comprises a time period.

21. The system of claim 19, further comprising an interface for the purchaser of an advertisement right or an authorized representative to upload an advertisement.

22. The system of claim 1, provided that prior to purchasing a syndication right, the user is able to test the content item by showing the content item to one or more people in order to obtain market feedback.

23. The system of claim 22, provided that the people comprise advertisers, broadcasters, critics, and members of the general public.

24. A computer implemented method for establishing syndication relationships comprising the steps of:
a. providing a database of content, the content susceptible to syndication in a plurality of geographic regions, provided that the content is submitted by the owner or authorized representative of the content;
b. providing a software module configured to provide an interface for a user to browse the content, the interface comprising a preview for each content item, a syndication availability in a first geographic region for each content item, and a number of advertisement breaks available for each content item;
c. providing a software module configured to provide an interface for the user to purchase a syndication right for a content item, the syndication right comprising: a purchase price and a second geographic region; and
d. on purchase of a syndication right, providing the user access to the content such that the user is able to broadcast the content according to the syndication right.

25. The method of claim 24, provided that access to the content comprises downloading the content, streaming the content, and hosting the content.

26. A computer readable storage media encoded with a computer program including instructions executable by a digital processing device to create a marketplace for forming syndication relationships comprising:
a. a database of content, the content susceptible to syndication in a plurality of geographic regions, provided that the content is submitted by the owner or authorized representative of the content;
b. a software module configured to provide an interface for a user to browse the content, the interface comprising a preview for each content item, a syndication availability in a first geographic region for each content item, and a number of advertisement breaks available for each content item; and
c. a software module configured to provide an interface for the user to purchase a syndication right for a content item, the syndication right comprising: a purchase price and a second geographic region.
